(19) United States
(12) Patent Application Publication
(10) Pub. No.: US 2008/0203899 A1
(43) Pub. Date: Aug. 28, 2008

(54) ELECTRO-LUMINESCENT DISPLAY WITH IMPROVED EFFICIENCY

(76) Inventors: Michael E. Miller, Honeoye Falls, NY (US); Paul J. Kane, Rochester, NY (US); Ronald S. Cok, Rochester, NY (US)

Correspondence Address: Frank Pincelli;Patent Legal Staff, Eastman Kodak Company, 343 State Street, Rochester, NY, 14650-2201, US

(21) Appl. No.: 11/680,244

(22) Filed: Feb. 28, 2007

(51) Int. Cl. H01J 1/62

(52) U.S. Cl. 313/499

(57) ABSTRACT

A full-color, light-emitting display device has improved efficiency with a large color gamut. The full-color, light-emitting display device has a plurality of pixels, each pixel having four or more colors of light-emitting elements. Three of the colors of light-emitting elements emits red, green, and blue light, and at least one of the colors of light-emitting elements emitting light is perceived to be within the gamut defined by the chromaticity coordinates of the red, green, and blue colored light-emitting elements. The light-emitting elements for emitting red, green, and blue colors of light each comprise a different species of inorganic light-emitting particles for emitting a different color of light. Each of the red, green, and blue species produces light having an emission spectrum with a full-width, half-maximum of less than or equal to 70 nm.

### FIELD OF THE INVENTION

The present invention relates to full-color electro-luminescent displays employing quantum dot light-emitting layers. Specifically, the invention relates to LED displays employing quantum dot white light-emitting elements.

### BACKGROUND OF THE INVENTION

In recent years, light-emitting devices have been demonstrated that apply quantum-dot emitting layers to form large-area light emission. One of the predominant attributes of this technology is the ability to control the wavelength of emission, simply by controlling the size of the quantum dot. As such, this technology provides the opportunity to relatively easily design and synthesize the emissive layer in these devices to provide any desired dominant wavelength, as well as control the spectral breadth of emission peaks. This fact has been discussed in a paper by Bulovic and Bawendi, entitled “Quantum Dot Light Emitting Devices for Pixelated Full Color Displays” and published in the proceedings of the 2006 Society for Information Display Conference. As discussed in this paper, differently sized quantum dots may be formed and each differently sized quantum dot will emit light at a different dominant wavelength. This emission ability provides opportunities for creating very colorful light sources that employ single-color emitters to create very narrow band and, therefore, highly saturated colors of light emission. This wavelength characteristic may be particularly desirable within the area of visual displays, which typically employ a mosaic of red, green, and blue light-emitting elements to provide a full-color display.

Within the information display application space, devices are desired to deliver a large color gamut with high efficiency. Within this application space, efficiency is typically measured in metrics, such as the number of candelas that are produced as a function of input current or power. Therefore, the two requirements of large color gamut and high efficiency are often in conflict with one another. This conflict occurs due to the fact that as the color gamut of the display is expanded, the red and blue emitters must often be shifted towards very short and very long wavelengths, respectively, and the human eye is much less sensitive to these wavelengths than to wavelengths of light near the center of the visible spectrum. This loss of sensitivity to energy at the extremes of the visible spectrum occurs because luminous efficiency, measured in candelas, is calculated by cascading the eye sensitivity function with the radiant power spectrum of light emission. FIG. 1 shows the efficiency function of the human eye, which shows the percent efficiency of the eye to converting energy at each wavelength within the visible spectrum to an increase in perceived brightness. As this figure shows, the human eye is most sensitive to energy with a wavelength of between 550 and 560 nm 2, but much less sensitive to a very short wavelength 4 or a very long wavelength 6 within the visible spectrum.

Although the loss of display efficiency that occurs as the color gamut of the display is increased, can be largely explained by this discussion of the red and blue emitters, the placement of the green emissive element is also quite important. FIG. 2 shows a 1931 CIE chromaticity diagram having two triangles. The first triangle 8 depicts the color gamut of an imaginary display having a green emissive element with a full-width at half maximum amplitude bandwidth of 30 nm, and a center wavelength at 533 nm. The second triangle 10 depicts a larger color gamut that may be achieved by shifting the center wavelength of a narrowband green emitter to 525 nm. As is readily apparent, the color gamut triangle 10 is significantly larger than the color gamut triangle 8, in fact the areas of the two triangles within this color space are 0.18 and 0.19, respectively. However, referring again to the function depicted in FIG. 1, it may be observed that shifting the center frequency of the green primary from 533 nm to 525 nm, which provides a larger color gamut, reduces the efficiency at which the human eye converts radiant power to perceived brightness from 90% to only 79%.

Numerous methods for improving the overall efficiency of a display device have been discussed in the literature. One such method is to simply select the RGB primaries to provide high efficiency while at the same time providing an “optimal gamut”, as suggested by William A. Thornton in a paper entitled, “Suggested Optimum Primaries and Gamut in Color Imaging,” published in Color Research and Application, vol. 25, No. 4. In this paper, the author suggests selecting the primaries of the display device to match the “prime colors” for the human visual system. As the author suggests, this would establish a system having emitters with center wavelengths of 450, 530, and 610 nm for the blue, green, and red emissive elements, respectively. This approach supposedly allows the display to provide maximum peak brightness for a given input energy if it is assumed that the radiant efficiency of each of the emitters is equivalent. Unfortunately, this approach limits the color gamut of the display. In fact, the color gamut 8 in FIG. 2 is obtained when the display uses light-emitting elements having these same peak wavelengths, each having a 30 nm bandwidth. Of further concern with this approach is that the red primary is particularly desaturated and the color of this primary may be more accurately described as orange rather than red. Therefore, while the approach described by Thornton does provide a display with good power efficiency, it would not provide a display with a particularly good visual appearance.

A second method, which has been discussed within the organic light-emitting diode art, involves the use of additional, more efficient, primaries to the typical three primary systems. For instance, Burroughes in WO 00/11728, entitled “Display Devices” describes an OLED system having red, green, and blue light-emissive elements and at least one further light-emissive element for emitting a color to which the human eye is more sensitive than the emission color of at least one of the red and blue emitters. Unfortunately, Burroughes fails to recognize that, in most applications, it is particularly important to render white with high efficiency, a fact that is discussed by Miller et al. in US Patent Application US2005/0212728, entitled “Color OLED Display With Improved Power Efficiency”. Miller et al. discusses the optimal power benefit when adding additional narrowband emitters to the display and the requirement of at least two additional light-emitting elements; one for emitting yellow light and one for emitting cyan light. Therefore, in devices such as these, which add additional saturated color primaries, it is typically necessary to add at least two additional emitters to achieve the maximum gains in power efficiency. However, the addition of each additional primary increases the manufacturing cost of the display device since additional elements must be formed and patterned to form each colored light-emitting element, requiring more precise patterning technology to allow these additional features to be patterned within the same plane as the original three light-emitting elements. Image quality of the display is also often sacrificed, as there is a need for a total of five emissive elements per pixel, two of which will often be inactive at any point in time.

Another approach discussed in the organic light emitting diode literature is to add a single, highly efficient, white light-emitting element to the display device, as discussed by Siwinski in U.S. Pat. No. 7,012,588, entitled, “Method For Saving Power In An Organic Electro-Luminescent Display Using White Light Emitting Elements”. Siwinski discloses that for a patterned, RGBW display, power efficiency gains on the order of 20% may be obtained. While this is a useful improvement in power efficiency, much larger improvements in power efficiency are required to justify the additional cost of patterning four colors of light-emissive elements in practical display devices. Similar displays employing organic light-emitting diodes have also been discussed by Miller et al. in U.S. patent application Ser. No. 10/320,195, entitled, “Color OLED Display With Improved Power Efficiency”, which showed somewhat larger power gains, but only for a few colors with primarily white content. This device employed white emissive elements with higher luminous efficiency than the green light-emitting element, indicating that the white light-emitting element had a higher radiant power efficiency than the green light-emitting element, since the green light-emitting element will emit light primarily near the peak in the human eye's efficiency function while a white light must emit light at some wavelengths to which the eye is much less sensitive. Once again, for emitters having equivalent radiant power efficiency, substantial gains in power efficiency are not clearly demonstrated.

Further, due to the general disorder of the molecular structure within organic light-emitting materials, emitters formed using this technology are relatively broadband, often having two or more peaks and effective bandwidths of 100 nm or more. Therefore, while this technology may be easily employed to create white light-emitting elements, it is difficult, if not impossible, to obtain displays with large color gamuts, unless this technology is applied with some additional color forming technology, such as color filters. This is demonstrated by the red 20, green 22, and blue 24 spectra shown in FIG. 3, which correspond to typical OLED red, green, and blue emissive elements. As shown, the primary peaks of these three emitters are located at about 605 nm, 520 nm, and 452 nm, respectively. Assuming a D65 white point, these emitters have a dominant wavelength of about 610, 545, and 475 nm, respectively. The color coordinates for these red 26, green 28, and blue 30 emissive elements, and their resulting color gamut 32 are shown in FIG. 4. The breadth of these organic emitters, allowing them to clearly form broadband light emission and whites, has been demonstrated with this technology. Unfortunately, the color gamut of emitters in such a system is often limited due to the breadth of their emission spectra.

There is a need, therefore, to provide a display having a very large color gamut and significantly higher luminance efficiency, while providing no more than one additionally colored light-emitting element per pixel, while employing emitters with roughly equivalent radiant efficiency.

### SUMMARY OF THE INVENTION

The aforementioned need is met according to the present invention by providing a full-color, light-emitting display device having improved efficiency with a large color gamut. The full-color, light-emitting display device has a plurality of pixels, each pixel having four or more colors of light-emitting elements. Three of the elements emit red, green, and blue light, and at least one of the elements emits light that is perceived to be within the gamut defined by the chromaticity coordinates of the red, green, and blue colored light-emitting elements. The light-emitting elements for emitting red, green, and blue colors of light each comprise a different species of inorganic light-emitting particles for emitting a different color of light. Each of the red, green, and blue species produces light having an emission spectrum with a full-width, half-maximum of less than or equal to 70 nm.

### BRIEF DESCRIPTION OF THE DRAWINGS

FIG. 1 is a plot of the human visual sensitivity function as a function of wavelength as known in the prior art;

FIG. 2 is a CIE x,y chromaticity diagram for two displays having different color gamuts for light-emitting elements having a 30 nm wide spectral peaks as known in the prior art;

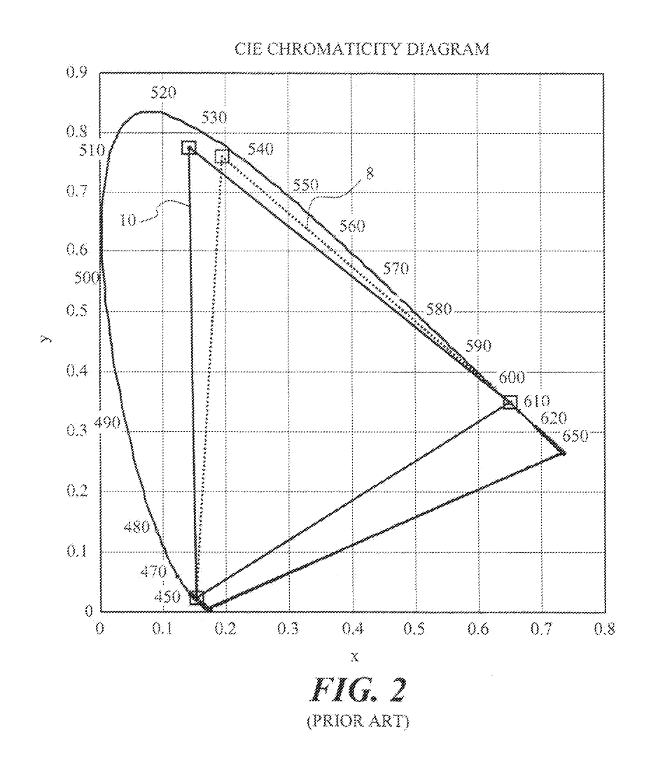

FIG. 3 illustrates the spectral power distribution for typical red, green, and blue OLED light-emitting elements as known in the prior art;

FIG. 4 is a CIE 1931 chromaticity diagram depicting chromaticity coordinates of the spectral power distributions shown in FIG. 3 and as known in the prior art;

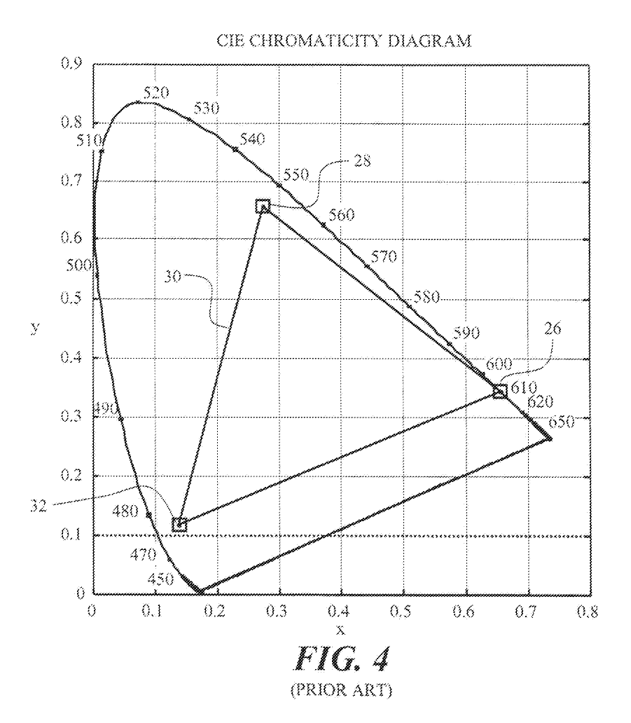

FIG. 5 is a portion of a top view of one embodiment of a display of the present invention;

FIG. 6 illustrates the spectral power distributions for three red, blue, green, and in-gamut light-emitting elements according to one embodiment of the present invention;

FIG. 7 is a CIE 1931 chromaticity diagram depicting coordinates of the light-emitting elements according to one embodiment of the present invention;

FIG. 8 illustrates the spectral power distributions for the three most efficient in-gamut, near-white light-emitting elements of the present invention wherein the chromaticity coordinates of the in-gamut light-emitting elements are equal to the chromaticity coordinates of a D95, D65, and D50 source;

FIG. 9 is a cross-sectional view of a device according to one embodiment of the present invention;

FIG. 10 is a flow chart depicting one set of steps for forming the light-emitting layer of a device of the present invention;

FIG. 11 is a CIE 1931 chromaticity diagram depicting coordinates defining three different potential color gamuts of displays;

FIG. 12a is a plot showing the power consumed by a display having red, green and blue primaries as shown in FIG. 9 as compared to the power consumed by a display including the same red, green and blue primaries as well as an in-gamut light-emitting element according to the present invention;

FIG. 12b is a plot showing the relative power consumed by a display having red, green and blue primaries as shown in FIG. 9 to the power consumed by a display including the same red, green and blue primaries as well as an in-gamut light-emitting element according to the present invention;

FIG. 13 is a 3-D plot showing the power consumed by a display of the present invention as a function of the CIE 1931 chromaticity coordinates of an in-gamut light-emitting element that is constructed according to the present invention;

FIG. 14 is a system for employing a display of the present invention;

FIG. 15 is an arrangement of red, green, blue and in-gamut light-emitting elements, useful for practicing a display of the present invention; and

FIG. 16 is a cross section of a light-emitting layer of the present invention.

### DETAILED DESCRIPTION OF THE INVENTION

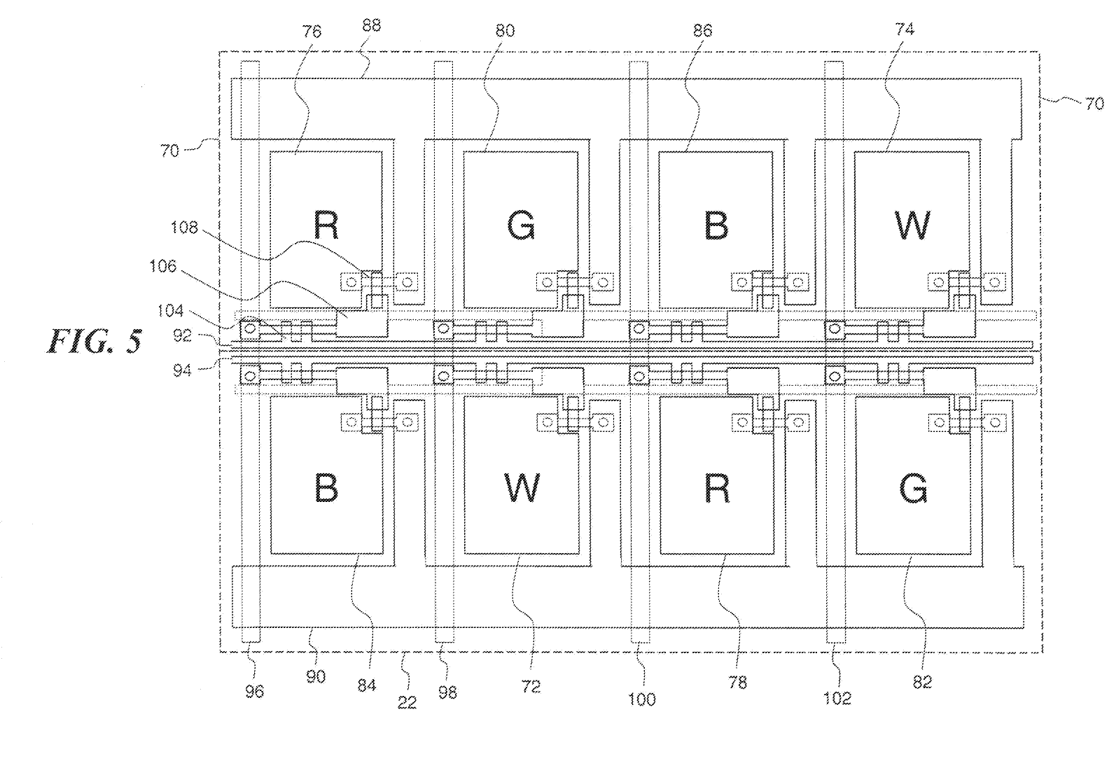

The present invention provides a full-color, light-emitting display device having improved efficiency with a large color gamut as shown in FIG. 5. FIG. 5 shows a portion 70 of a display comprising a plurality of pixels, each pixel having four or more colors of light-emitting elements, three of the colors of light-emitting elements emitting red 76, 78, green 80, 82, and blue 84, 86 light; and at least one of the colors of light-emitting elements 72, 74 emitting light perceived to be within the gamut defined by the chromaticity coordinates of the red, green, and blue colored light-emitting elements. Further, the light-emitting elements for emitting red 76, 78, green 80, 82, and blue 84, 86 colors of light each comprise a different species of inorganic light-emitting particles for emitting a different color of light, and each of the red, green, and blue species produce light having an emission spectrum with a full-width, half-maximum of less than or equal to 70 nm. Finally, the species of inorganic light-emitting particles for emitting red light emits light having a dominant wavelength of 620 nm or greater; the species of inorganic light-emitting particles for emitting blue light, emits light having a dominant wavelength of 470 nm or less; and the in-gamut light-emitting element employs a plurality of species of light-emitting particles, wherein at least one of the plurality of species of light-emitting particles has a greater luminous efficiency than both the red and the blue species of light-emitting elements that define end points of the gamut.

Within this description, the term “dominant wavelength” of a light-emitting element is defined as the wavelength of the monochromatic stimulus that, when additively mixed in suitable proportions with a specified achromatic stimulus, yields a color match with the color of the light-emitting element. Typically, the achromatic stimulus within this definition will be the white point of the display (i.e., the color of light that is produced when the red, green, and blue light-emitting elements are driven to their maximum code values). Since it is difficult and expensive to manufacture a large number of light-emitting particles that emit light at the same frequency, any practical light-emitting element employing light-emitting particles will have same variation in light output frequency, leading to a full-width half maximum bandwidth greater than zero. The term “species” of light-emitting particles refers to light-emitting particles intended to have a common light-emission spectrum. Hence, in practice, light-emitting of a common species may have some unintended variation in spectra.

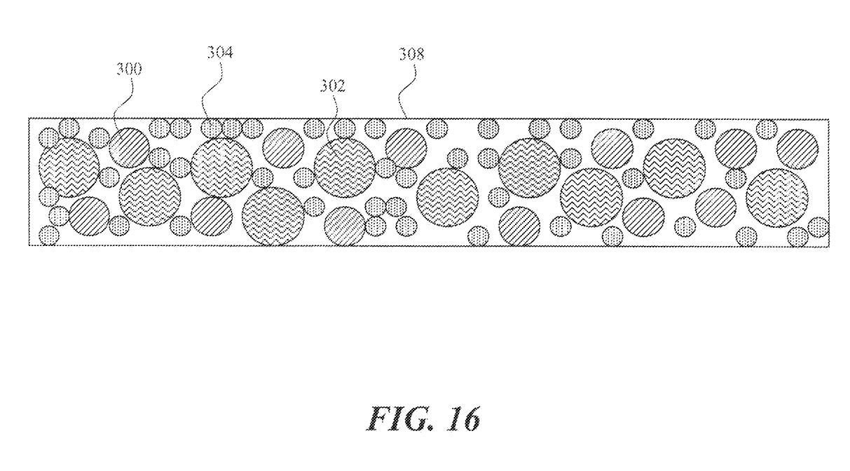

Within, a device of the present invention the light-emitting particles form a common, light-emitting layer, such as the one shown in FIG. 16, from which light will be emitted. This layer will be referred to as the light-emitting layer 308. The light-emitting layer 308 will typically be different within each light-emitting element. For example, in a display employing quantum dots as the light-emitting particles the red, green and blue light-emitting elements will each employ quantum dots that are of approximately equal size. However, the at least one of the colors of light-emitting elements 72, 74 emitting light perceived to be within the gamut will typically be comprised of at least two different sizes of quantum dots, including smaller quantum dots 300 for emitting shorter wavelength light and larger quantum dots 302, for emitting longer wavelength light. These particles will be form the common light-emitting layer 308. Additionally, the light-emitting layer 308 may further include non-light-emitting inorganic conductive or semi-conductive particles 304 for promoting the migration of holes and electrons within this common layer.

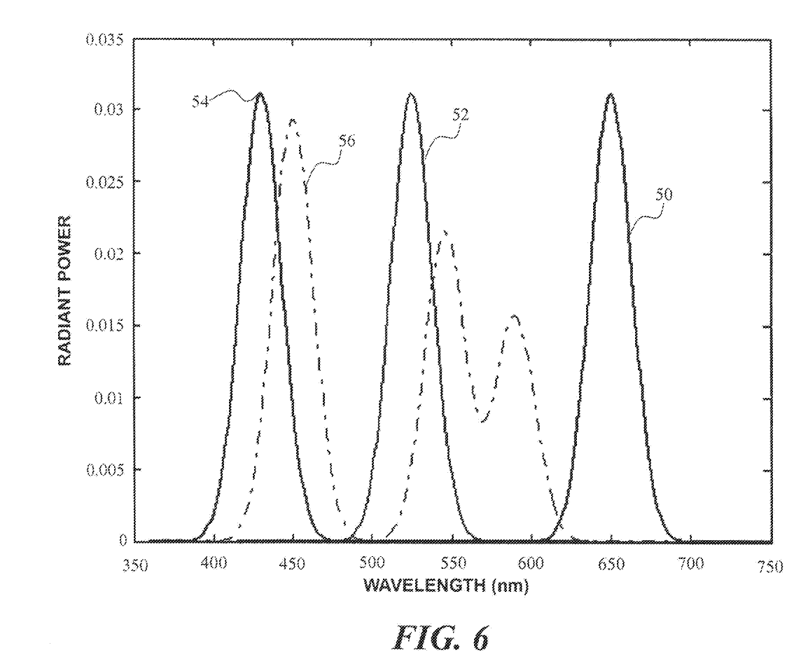

As noted, earlier, the spectral properties of the light output by the light-emitting particles are important to the present invention. FIG. 6 shows light emission spectra for red 50, green 52, blue 54 and an in-gamut or “white” 56 light-emitting element useful in practicing this invention. As shown, the red 50, green 52, and blue 54 light-emitting elements each have narrow full-width at half maximum bandwidths of under 70 nm and preferably significantly narrower than 70 nm. For example the bandwidths may be under 50 nm and may be as narrow as 30 nm. This particular attribute is important as it allows a large color gamut to be achieved and allows the peaks of the short (blue) 54 and long (red) 50 wavelength emitters to be positioned near the limits of the human visual sensitivity function without producing emission within the ultraviolet and infrared portions of the electromagnetic spectrum to which the human visual system is not sensitive. However, a narrow spectrum may be more expensive to manufacture, hence, according to various embodiments of the present invention, a tradeoff between cost, color gamut, and efficiency may be employed by varying the spectral bandwidth of the light-emitting species. The narrow-band emission spectra required for the red 50, green 52 and blue 54 light-emitting elements, are enabled by the use of species of the inorganic light-emitting particles (e.g., quantum dots) of the present invention. Further, the red light-emitting element has a spectra 50 having a dominant wavelength of 620 nm or greater and the blue light-emitting element has a spectra 54 with a dominant wavelength of 470 nm or less. In more preferred embodiments, the red light-emitting element will have a spectra 50 having a dominant wavelength of 670 nm or greater. Further, the blue light-emitting element will have a spectra 54 having a dominant wavelength of 430 nm or less.

The light-emitting particles within this invention may be any inorganic light-emitting elements that may be coated to form multiple light-emitting elements on a single display surface or substrate. One particularly useful light-emitting particle is the quantum dot. These particles are particularly desirable, as they may be coated as a light-emitting layer onto a single substrate. Such a light-emitting layer may be formed initially as a colloid of light-emitting particles, dispersed in a solvent, coated over a substrate, and dried. Additional non-light-emitting, electrically conductive particles may be included in the dispersion and, once dried, the dispersion may be annealed. Further, light-emitting elements formed from quantum dots will emit very narrow bandwidth light that has a full bandwidth at half maximum amplitude of less than 50 nm, and typically will have bandwidths on the order of 30 nm. These narrow bandwidths enable the attributes of this display as described in the previous paragraph. In addition to the red, green, and blue light-emitting elements, the display has at least one color of light-emitting element for emitting light perceived to be within the gamut defined by the red, green, and blue light-emitting elements. The spectra of one such light-emitting element 56 is also shown in FIG. 6. Such a light-emitting element may be formed by employing numerous methods, including simply employing red and/or blue light-emitting elements having spectra with dominant wavelengths shorter than 650 nm or longer than 450 nm. Calculations performed by the authors have shown that to obtain substantial power savings the in-gamut light-emitting element should preferably employ a plurality of species of light-emitting particles such that this light-emitting element has a greater luminous efficiency than both the red and blue species and allows the display to rely less on both the red and blue light-emitting elements for the production of near-neutral colors, which are the most commonly used colors within any display system. Within the emission spectra shown in FIG. 6, the additional light-emitting element contains light-emitting particles that emit light at wavelengths of about 450 nm, 495 nm, and 585 nm, each of which fall between the peak frequencies of the red light-emitting element and the blue light-emitting element, and are, therefore, closer to the peak of the human visual sensitivity curve than are either of these emitters. By providing a more efficient method of forming near-neutral colors, this mechanism allows a display with an improved energy efficiency to be formed.

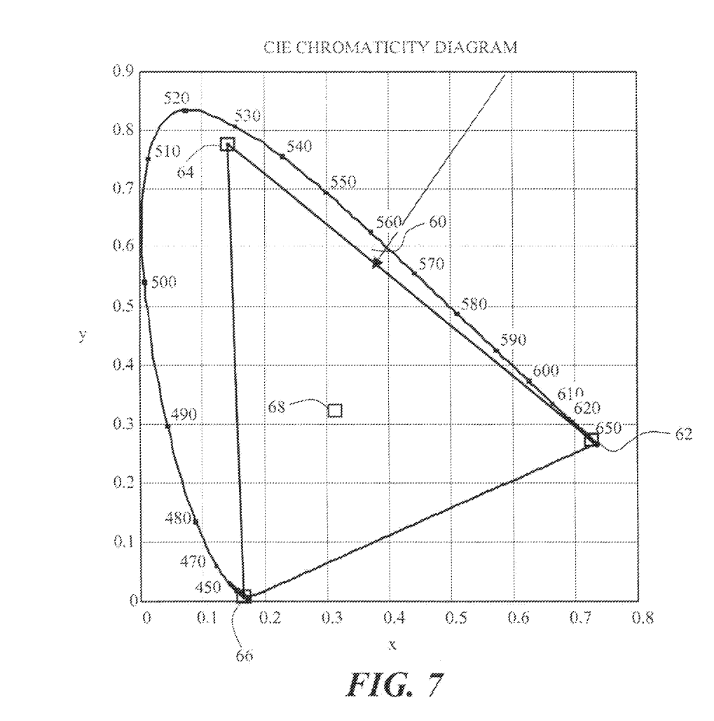

FIG. 7 shows the CIE coordinates for the emitter spectra shown in FIG. 6. As shown in FIG. 7, the color gamut of the display is the triangle 60, which is defined by the colors of light produced by the red light emitting element 62, the green light-emitting element 64 and the blue light-emitting element 66. The color of the additional light-emitting element 68 is located within the color gamut of the display.

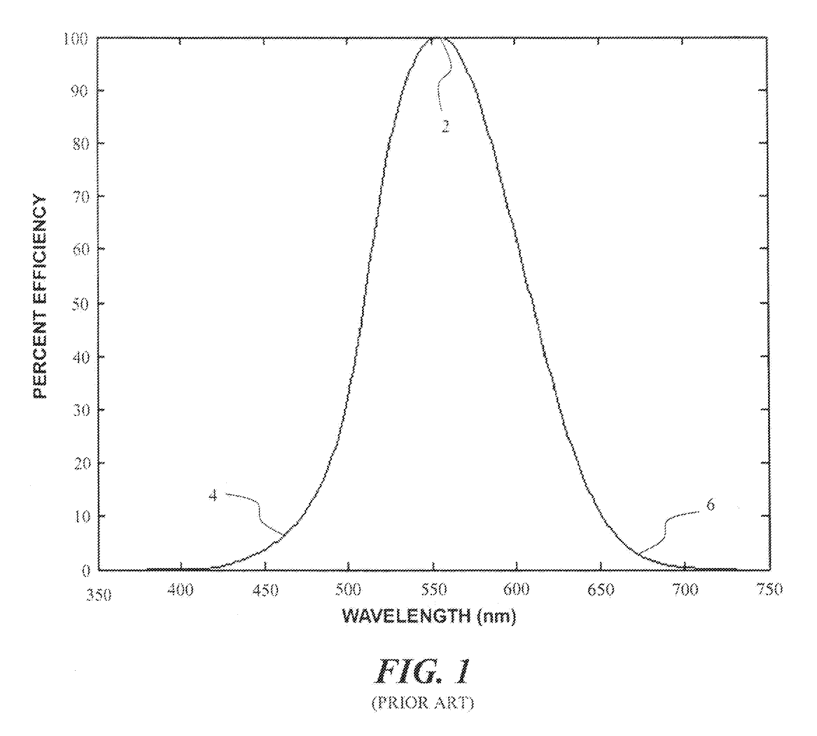

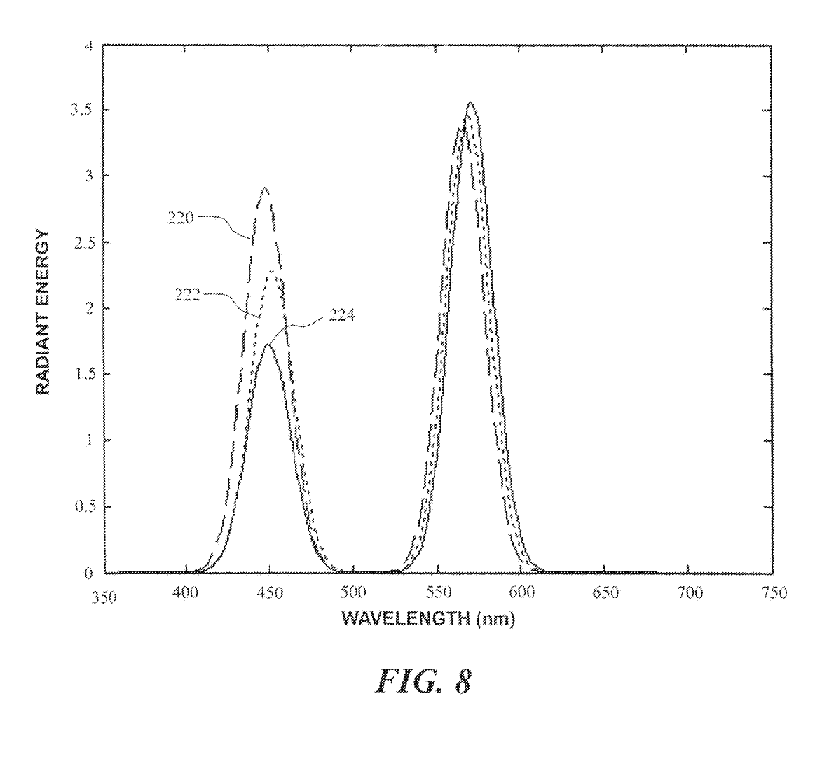

Although the additional light-emitting element may be formed from an in-gamut white light-emitting element having virtually any spectral content, it is recognized that some emitters having two emission peaks will be very efficient and require inclusion of only two species of light-emitting particles. FIG. 8 provides a plot of the radiant power as a function of wavelength for the three most efficient, separate in-gamut light-emitting elements 220, 222, and 224 for forming the three most common daylight white points of D50, D65, and D93 from a pair of 30 nm wide emission peaks. As shown, the three spectra contain a first emission peak at 450, 452, and 448 nm, respectively as well as a second emission peak of 571, 569, and 566 nm, respectively. Notice that each of the emission spectra contain two separate and distinct peaks, one of which is near the peak in the human visual sensitivity function shown in FIG. 1 (which has a peak between 550 and 560 nm) and which therefore has a high efficacy for stimulating the human visual system. This high efficacy provides an emissive light-emitting element with high luminance efficiency. For instance, the efficiency with which light from light-emitting elements having these three spectral distributions would be converted from radiance to luminance would be 63, 70 and 53 percent for the D50, D65, and D93 light sources, respectively. These efficiencies compare vary favorably to most other emitter spectral distributions that could be employed, especially broadband spectra. For example, light sources having a single broadband spectral distribution, equivalent to a blackbody radiator at temperatures of 5000, 6500, and 9300 degrees Kelvin would have conversion efficiencies of only 30, 28 and 25 percent respectively; all of which are half as efficient as the optimal spectral distributions provided by a device of the present invention, but all of which would still be substantially higher in efficiency than the red or blue light-emitting elements of the present invention.

An important attribute of the in-gamut light-emitting element is that at least one of the pluralities of species of light-emitting particles emit light at a wavelength that is between the wavelength of light produced by the light-emitting particles for producing red and blue light. As such, one of these particles will typically emit light that may be classified as orange, cyan, green-cyan, or yellow light. Typically, at least one of the pluralities of species of light-emitting particles of the in-gamut light-emitting element emits light at a frequency different from the frequency of light emitted by the red, green, or blue species of light-emitting particles. Further, since the in-gamut light-emitting element may produce white light and this light-emitting element may employ two species of light-emitting particles, the plurality of species of light-emitting particles of the in-gamut light-emitting element will often emit light of two complementary colors (e.g., blue and yellow, or cyan and red). These complementary color pairs will typically consist of a primary (red, green or blue) and a secondary (yellow, cyan, and magenta) color. However, more species of light-emitting particles may be involved, in which case, the additional light-emitting particles may emit green light, orange or yellow light, or cyan light in addition to the complementary colors. It should also be noted, that while the light-emitting particles that form the light-emitting layer of the in-gamut light-emitting element will typically emit light that is different in frequency than any of the red, green, or blue light-emitting elements, this is not required and at least one of the plurality of species of light-emitting particles of the in-gamut light-emitting element may emit light of a frequency that is the same as one of the red, green, or blue species of light-emitting particles which form the red, green, and blue light-emitting elements.

A display of the present invention may be formed by applying quantum dot light-emitting layers, wherein the red, green, and blue light-emitting elements have quantum dots of one size which form the species of inorganic light-emitting particles for forming each of the red, green, and blue light-emitting elements. The in-gamut light-emitting element of the present invention may be formed by placing two or more sizes of quantum dots within the emitting layer of a single light-emitting element, forming the two or more species of inorganic light-emitting particles. The formation of a single light-emitting element from two different sizes of quantum dots, wherein each size of quantum dot having light output with distinctly different dominant wavelengths is employed in one method of forming multiple species within a common light-emitting element. However, other mechanisms may also be used to create the functionally different species, including applying different materials in the fabrication of one quantum dot versus another or providing different environmental conditions for one quantum dot versus another.

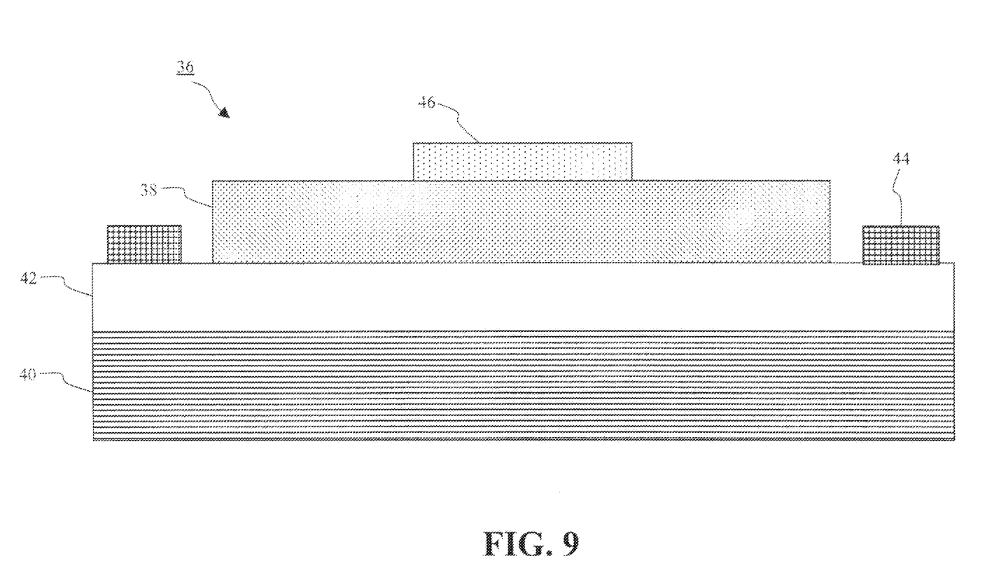

FIG. 9 shows a cross sectional view of a light-emitting element useful in practicing the present invention. As shown in this figure, the LED device 36 incorporates the quantum dot inorganic light-emitting layer 38. A substrate 40 supports the deposited semiconductor and metal layers; its only requirements are that it is sufficiently rigid to enable the deposition processes and that it can withstand the thermal annealing processes (maximum temperatures of ˜285° C.). It can be transparent or opaque. Possible substrate materials are glass, silicon, metal foils, and some plastics. The next deposited material is an anode 42. For the case where the substrate 40 is p-type Si, the anode 42 needs to be deposited on the bottom surface of the substrate 40. A suitable anode metal for p-Si is Al. It can be deposited by thermal evaporation or sputtering. Following its deposition, it will preferably be annealed at ˜430° C. for 20 minutes. For all of the other substrate types named above, the anode 42 is deposited on the top surface of the substrate 40 and is comprised of a transparent conductor, for example, indium tin oxide (ITO). Sputtering or other well-known procedures in the art can deposit the ITO. The ITO is typically annealed at ˜300° C. for one hour to improve its transparency. Because the sheet resistance of transparent conductors, such as, ITO, are much greater than that of metals, bus metal 44 can be selectively deposited through a shadow mask using thermal evaporation or sputtering to lower the voltage drop from the contact pads to the actual device. Next inorganic light emitting layer 38 is deposited. It can be dropped or spin cast onto the transparent conductor (or Si substrate). Other deposition techniques, for example, inkjetting the quantum dot-inorganic nanoparticle dispersion is also possible. Following the deposition, the inorganic light-emitting layer 38 is annealed at a preferred temperature of 270° C. for 50 minutes. Lastly, a metal cathode 46 is deposited over the inorganic light-emitting layer 38. Candidate metals for cathode 46 are metals that form an ohmic contact with the material comprising the inorganic nanoparticles 38. For example, in a case where the quantum dots are formed from ZnS inorganic nanoparticles, a preferred metal is Al. Aluminum can be deposited by thermal evaporation or sputtering, followed by a thermal anneal at 285° C. for 10 minutes. Although not shown in FIG. 9, a p-type transport layer and an n-type transport layer may be added to the device to surround the inorganic light-emitting layer 38. As is well known in the art, LED structures typically contain doped n- and p-type transport layers. They serve a few different purposes. Forming ohmic contacts to semiconductors is simpler if the semiconductors are doped. Since the emitter layer is typically intrinsic or lightly doped, it is much simpler to make ohmic contacts to the doped transport layers. As a result of surface plasmon effects, having metal layers adjacent to emitter layers results in a loss of emitter efficiency. Consequently, it is advantageous to space the emitter layers from the metal contacts by sufficiently thick (at least 150 nm) transport layers. Finally, not only do the transport layers inject electron and holes into the emitter layer, but, by proper selection of materials, they can prevent the leakage of the carriers back out of the emitter layer. For example, if the inorganic quantum dots in the light-emitting layer 38 were composed of ZnS_{0.5}Se_{0.5} and the transport layers were composed of ZnS, then the electrons and holes would be confined to the emitter layer by the ZnS potential barrier. Suitable materials for the p-type transport layer include II-VI and III-V semiconductors. Typical II-VI semiconductors are ZnSe, ZnS, or ZnTe. Only ZnTe is naturally p-type, while ZnSe and ZnS are n-type. To get sufficiently high p-type conductivity, additional p-type dopants should be added to all three materials. For the case of II-VI p-type transport layers, possible candidate dopants are lithium and nitrogen. For example, it has been shown in the literature that Li₃N can be diffused into ZnSe at ˜350° C. to create p-type ZnSe, with resistivities as low as 0.4 ohm-cm.

Suitable materials for the n-type transport layer include II-VI and III-V semiconductors. Typical II-VI semiconductors are ZnSe or ZnS. As for the p-type transport layers, to get sufficiently high n-type conductivity, additional n-type dopants should be added to the semiconductors. For the case of II-VI n-type transport layers, possible candidate dopants are the Type III dopants of Al, In, or Ga. As is well known in the art, these dopants can be added to the layer either by ion implantation (followed by an anneal) or by a diffusion process. A more preferred route is to add the dopant in-situ during the chemical synthesis of the nanoparticle. Taking the example of ZnSe particles formed in a hexadecylamine (HDA)/TOPO coordinating solvent, the Zn source is diethylzinc in hexane and the Se source is Se powder dissolved in TOP (forms TOPSe). If the ZnSe were to be doped with Al, then a corresponding percentage (a few percent relative to the diethylzinc concentration) of trimethylaluminum in hexane would be added to the syringe containing TOP, TOPSe, and diethylzinc. In-situ doping processes like these have been successfully demonstrated when growing thin films by a chemical bath deposition. It should be noted the diode could also operate with only a p-type transport layer or an n-type transport layer added to the structure. Those skilled in the art can also infer that the layer composition can be inverted, such that, the cathode 46 is deposited on the substrate 40 and the anode 42 is formed on the p-type transport layer. For the case of Si supports, the substrate 40 is n-type Si.

The light-emitting layer 38 will preferably be comprised of a plurality of light-emitting cores, each core having a semiconductor material that emits light in response to recombination of holes and electrons, each such light emitting core defining a first bandgap; a plurality of semiconductor shells formed respectively about the light emitting cores to form core/shell quantum dots, each such semiconductor shell having a second bandgap wider than the first bandgap; and a semiconductor matrix connected to the semiconductor shells to provide a conductive path through the semiconductor matrix and to each such semiconductor shell and its corresponding light-emitting core so as to permit the recombination of holes and electrons.

At least one of the two electrodes (i.e., anode 42 or cathode 46) will typically be formed of a transparent or semi-transparent material such as ITO or indium zinc oxide (IZO). The opposing electrode will often be formed of a highly reflective material such as aluminum or silver; but the opposing electrode may also be transparent. In a typical embodiment, the anode will be transparent and the cathode will be reflective, but the reverse structure is also viable. The hole and electron transport materials may be formed from inorganic semi-conducting materials as described above, alternatively the hole and electron transport materials may also be formed from organic semi-conducting materials. Additional layers may also be placed into the structure to promote other functions, such as electron and hole injection from the electrodes; or electron or hole blocking layers to prevent electrons or holes from traveling past the light-emitting layer to recombine with oppositely charged particles near one of the electrodes.

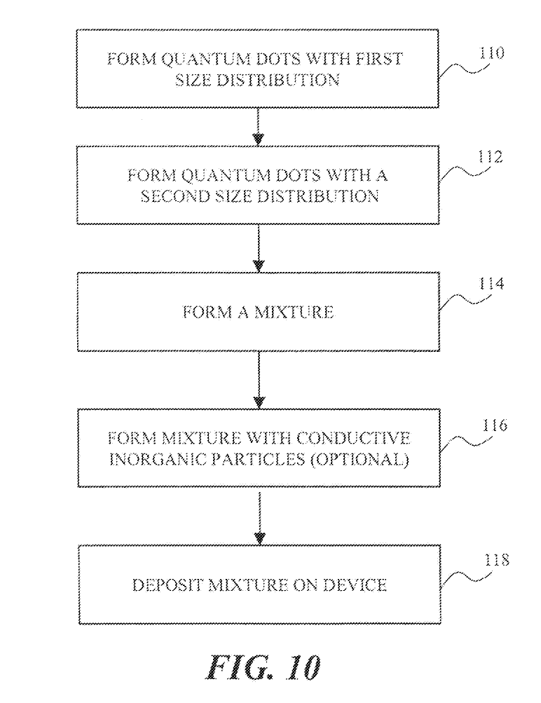

The creation of a light-emitting layer within the in-gamut light-emitting element, which is comprised of a plurality of species of light-emitting particles, such as quantum dots, allows each particle to produce light that has a single dominant wavelength, but wherein the combination of light from the particles allows light to be created within a single light-emitting element, which has two or more distinctly different dominant wavelengths. The creation of such a light-emitting layer will generally involve synthesizing species of light-emitting particles, such as quantum dots of a first and second size within separate steps and then depositing these quantum dots in the correct proportion into the light-emitting layer of a device. One process for fabricating such a device is depicted in FIG. 10. In this process, a first size distribution of quantum dots will be formed in operation 110. One such process has been discussed in co-pending U.S. application Ser. No. 11/226,622, filed Sep. 14, 2005 by Kahen, which is hereby included by reference. A second size distribution of quantum dots will also be formed operation 112 using a similar process but will result in different sizes by varying the parameters of the reaction (e.g., time, temperature, or concentrations) that are used to form the quantum dots. A mixture of the two distributions will then be formed operation 114 by combining the resulting quantum dots into a common mixture containing quantum dots from each of the two size distributions. This mixture will contain a proportion of the number of quantum dots from the first size distribution to the number of dots from the second size distribution such that the proportion is approximately equal to the desired area under each of the peaks within the desired spectral power distribution, such as the one shown in FIG. 10. That is, the proportion of the number of quantum dots from the size distribution corresponding to light emission of a first peak to the number of quantum dots from the size distribution corresponding to light from a second peak will be equal to the area under the first peak to the area under the second peak. An optional operation, operation 116 forms a mixture of the two distributions or sizes of quantum dots with additional conductive inorganic particles may be performed. These additional conductive inorganic particles can, in some embodiments be useful in forming a semi-conductor matrix, promoting the flow of holes and electrons to the quantum dots. Once this mixture of quantum dots is formed, the mixture is deposited in operation 118 onto the device using means as are known in the prior art.

Returning to the discussion of FIG. 5, the light-emitting elements will typically be patterned beside each other to form a full-color display. While portion 70 of the full-color display, as shown in FIG. 5, applies active matrix circuitry to drive the light-emitting elements of the display device, the display device may also apply passive-matrix circuitry.

As shown in FIG. 5, active matrix circuitry for driving a device of the present invention will typically include power lines 88, 90 for providing current to the light-emitting elements, select lines 92, 94 for selecting a row of circuits, drive lines 96, 98, 100, 102 for providing a voltage to control each of the circuits, select TFTs 104 for allowing the voltage for a drive line 96, 98, 100, 102 to be provided only to the light-emitting elements in a column that receive a select signal on a select line 92 or 94, a capacitor 106 for maintaining a voltage level between each line refresh and a power TFT 108 for controlling the flow of current from the power lines 88, 90 to one of the electrodes for each light-emitting element.

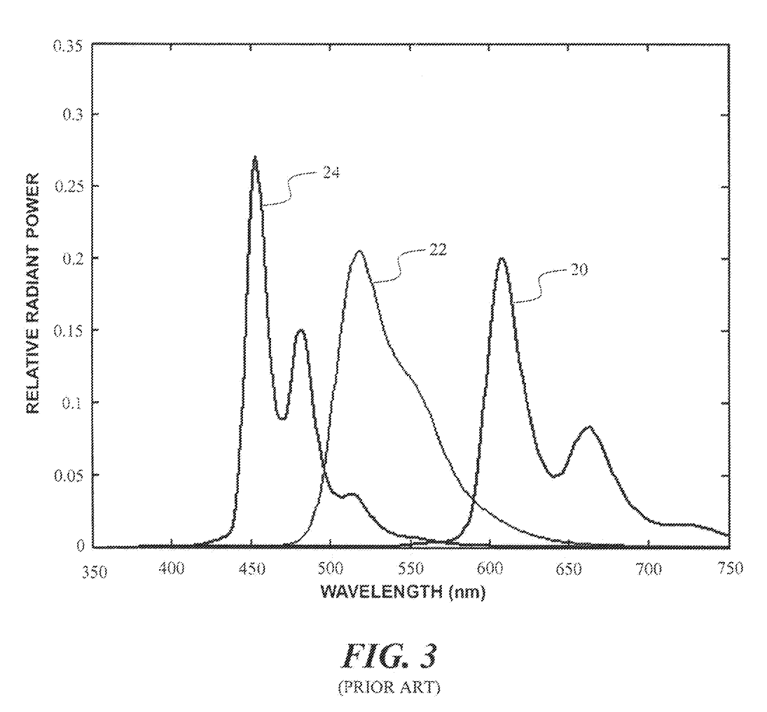

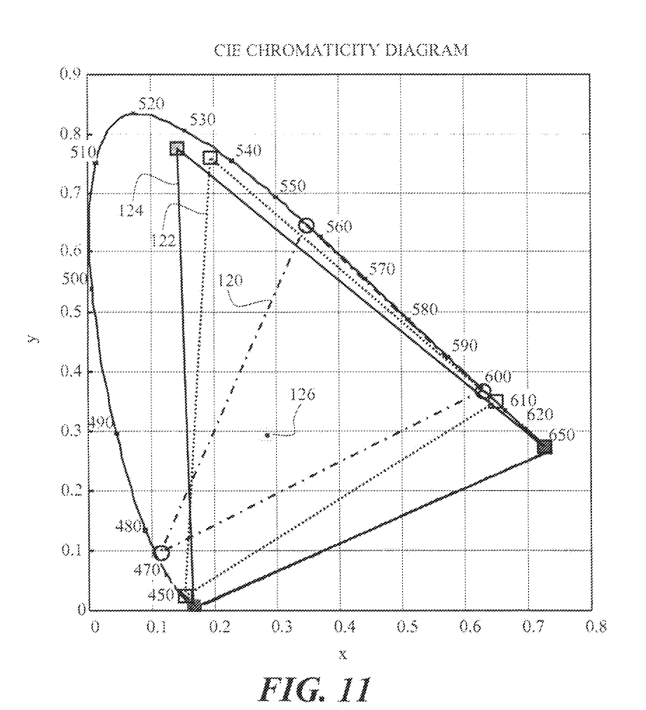

In such a display, the color of light emitted by the elements emitting red, green, and blue light will define the color gamut of the display, wherein the color gamut is defined as the area enclosed by the chromaticity coordinates of the red, green, and blue light-emitting elements for emitting at least three additional colors of light. This area is often expressed as a percentage of the area that is defined by chromaticity coordinates specified in the NTSC standard. FIG. 11 shows three potential color gamuts 120, 122, 124 that may be created by applying three independent sets of additional light-emitting elements when plotted in the CIE 1931 chromaticity coordinate space. Included in this figure, is a first color gamut 120 having an area that is equal to approximately 70% of the NTSC color gamut area, which is typical of traditional flat-panel displays, a second color gamut 122 having an area that is equal to approximately 100% of the NTSC color gamut area, and a third color gamut 124, having an area that is approximately 138% of the area of the NTSC color gamut area, which is only achievable in displays having extraordinarily narrow band emitters such as laser displays and displays employing quantum dots. Also shown in this figure is the chromaticity coordinate 126 of a near white light emitting element for emitting a near-white color of light having the spectral content shown in FIG. 3. Note also, that only the display having the third color gamut 124 has red and blue light-emitting elements with spectral peaks that are greater than 620 and less than 470 nm, respectively. Therefore only the display with the color gamut 124 is an embodiment of the present invention.

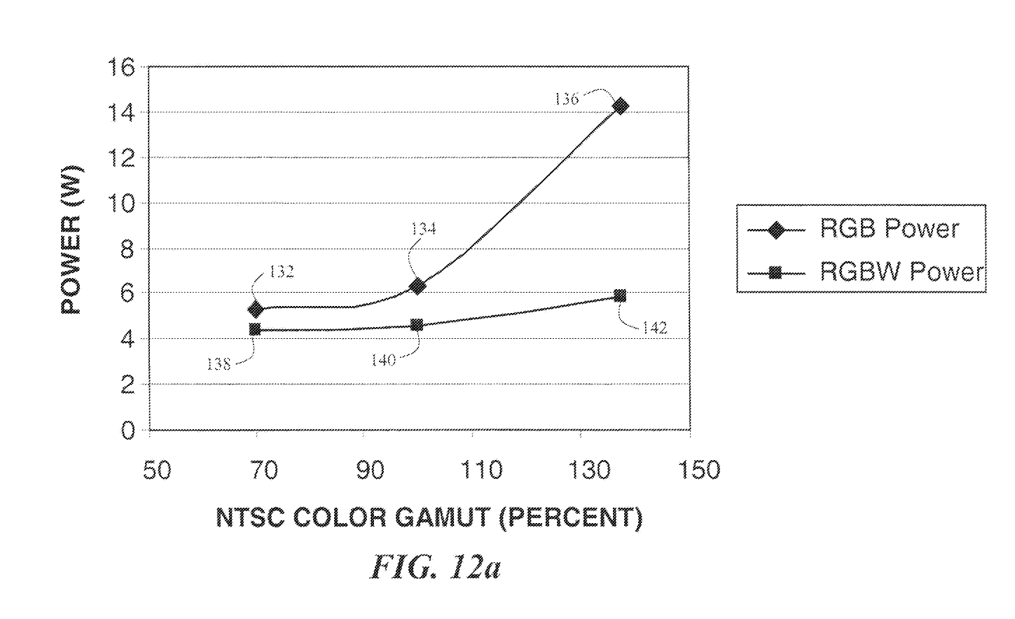

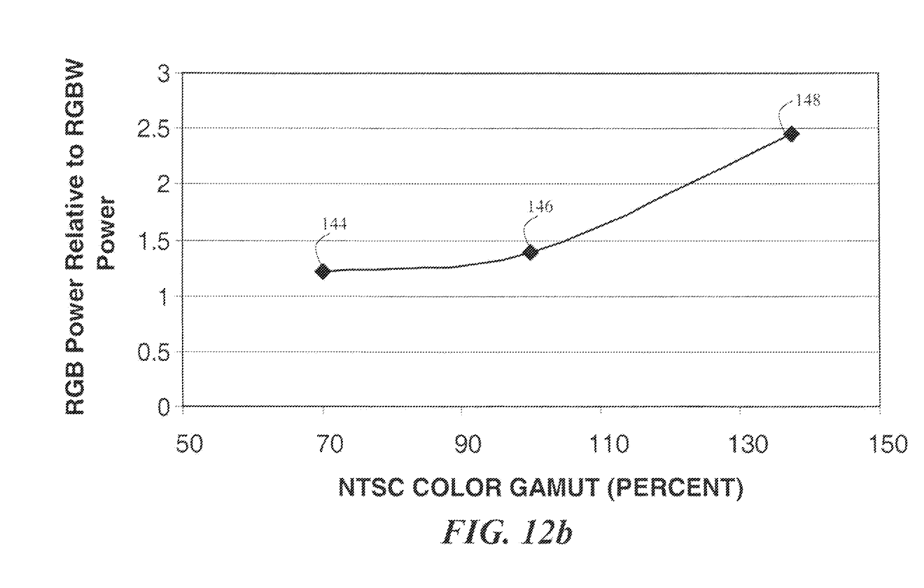

In a full-color display of the present invention, the primary purpose of the near white light-emitting element, which is comprised of a plurality of species of light-emitting particles, such as quantum dots, is to reduce the power consumption of the display. The effect of employing this light-emitting element upon the power consumption of a full-color display of the present invention is shown in FIG. 12a. This figure shows the relative average power consumption of three displays 132, 134, 136 having only the red, green and blue light-emitting elements as depicted in FIG. 11 as having color gamuts 120, 122, and 124. However, when the same near-white light-emitting element for emitting a near-white color of light is added to these displays and images are rendered appropriately, the average power consumption of the display is reduced to the relative power consumptions 138, 140, and 142, respectively. FIG. 12b shows the ratios 144, 146, 148 of the relative average power consumption values of the three displays 132, 134 136 having only red, green, and blue primaries to the relative average power consumption values 138, 140, 142 for a display having the near-white light-emitting element for emitting the near-white color of light as a function of the color gamut of the display. As shown in this figure, the advantage of this emitter varies significantly as a function of the color gamut of the display. As shown, the presence of the in-gamut light-emitting element for emitting a near-white color of light significantly improves the power consumption of the display of the present invention, improving its power efficiency by a factor of nearly 2.5. However, for displays having smaller color gamuts, as are known in the art and described by Siwinski and others, this power benefit is relatively small, providing an improvement factor of only 1.2.

Within a display system employing quantum dot light-emitting elements, the radiant efficiency of the light-emitting element is relatively independent of the color of light emission. Therefore, it may be assumed that the radiant efficiency of each of the different colors of the light-emitting elements will be relatively equivalent. Any reduction in display power consumption is then due to the sensitivity of the human eye to the spectral energy of each light-emitting element. Table 1 shows the relative luminance efficiencies (efficiency with which the human eye converts radiant energy having the peak wavelength and a bandwidth of 30 nm to luminance) for each of the primaries depicted within FIG. 8. Included are the relative efficiencies of the in-gamut light-emitting element (labeled white efficiency) and the efficiencies for each of the red, green and blue light-emitting elements (labeled red, green, and blue efficiency) for each of the three-color gamuts. As shown, the relative luminance efficiency of the in-gamut light-emitting elements is higher than the relative luminance efficiency of the red and blue light-emitting elements. That is, the luminance efficiency of the in-gamut light-emitting element is higher than the luminance efficiency of at least two of the at least three additional light-emitting element for emitting at least three colors of light.

TABLE 1

| NTSC | | | | |
|---|---|---|---|---|
| Color | Red | Green | Blue | White |
| Gamut | Efficiency | Efficiency | Efficiency | Efficiency |
| 138 | 0.7 | 75.3 | 0.7 | 57.6 |
| 100 | 1.1 | 89.7 | 16.0 | 48.59 |
| 70 | 6.7 | 96.5 | 13.0 | 44.6 |

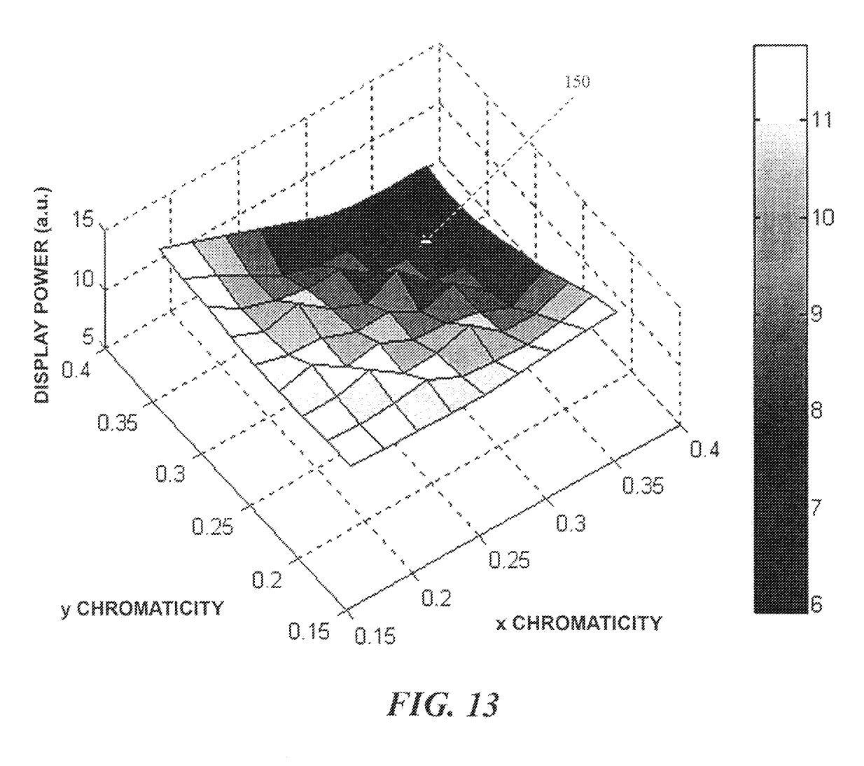

To obtain the maximum reduction in display power consumption, it is important that the 1931 CIE chromaticity coordinates of the in-gamut light-emitting element approximately equal the CIE chromaticity coordinates of the white point of the display. Herein, the white point of the display is defined as the color that is displayed when an object having maximum RGB code values in the RGB color space is presented on the display. A plot showing average power consumption of a full-color display as a function of the 1931 CIE chromaticity coordinates of the near white light emitting element for emitting a near-white color of light is shown in FIG. 13. As this figure shows, the minimum power consumption 150 occurs when the color of the in-gamut light-emitting element has x and y chromaticity coordinates of 0.310, and 0.318 when the white point of the display has x and y chromaticity coordinates of 0.285, 0.293, respectively. However, the chromaticity coordinates of the in-gamut light-emitting element having the minimum power consumption will depend somewhat upon the white point of the display, the chromaticity coordinates of the red, green, and blue primaries of the display and the exact spectra of the in-gamut light-emitting element. The chromaticity coordinates of the in-gamut light-emitting element may lie within 0.2 of both the x and y chromaticity coordinates of the white point of the display, or may lie within 0.1 of both the x and y chromaticity coordinates of the chromaticity coordinates of the white point of the display and may typically lie within 0.05 of the x and y chromaticity coordinates of the white point of the display.

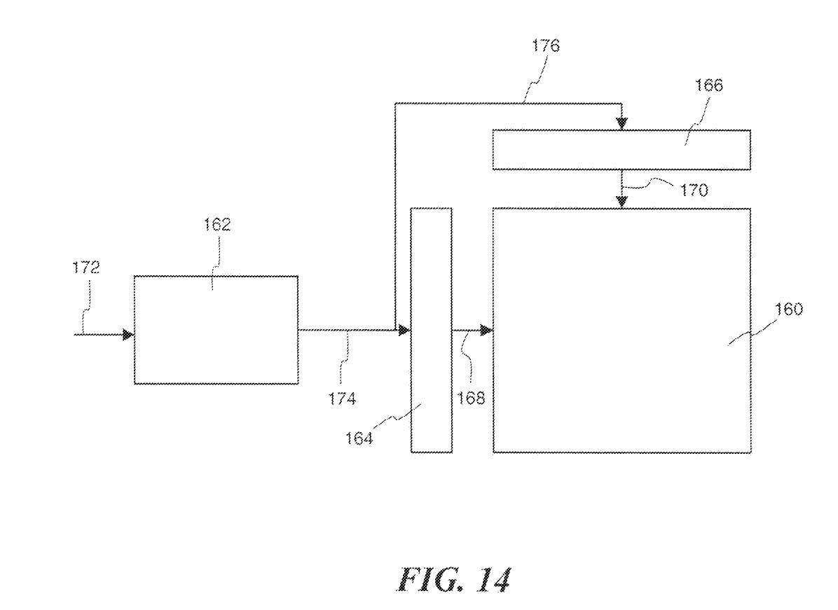

The full-color display of the present invention may be employed within a display system as shown in FIG. 14. As shown in this figure, such a display system would involve a display 160 according to one embodiment of the present invention, such as the one of which a portion is shown in FIG. 5, and a display processors for providing appropriate row 168 and column 170 signals to the display 160. Typically, display processor 162 will include row drivers 164, and column drivers 166. The display processor 162 will typically receive an input digital RGB signal 172 for the image that is to be displayed and convert this signal to provide a synchronization signal 174 to the row drivers 164, and a four or more color signals 176 to the column drivers 166, for driving the near white light-emitting element and the three or more additional light-emitting elements. Methods for performing this conversion are known in the art and include processes such as described in U.S. Pat. Nos. 6,897,876 and 6,885,380 as well as co-pending U.S. application Ser. Nos. 11/429,884, 11/429,839, 11/429,704, and 11/429,838 all filed May 8, 2006 by Miller et al., all of which are herein included by reference. Generally, these methods consist of subtracting at least a portion of the red, green, and blue code values from these input code values and assigning some proportion of this same value to the drive value of the near-white light-emitting element for emitting a near-white color of light. In this way, the near-white light-emitting element, for emitting a near-white color of light, is preferentially employed to produce luminance that would have otherwise been produced by the red, green, and blue light-emitting elements. Once this signal is received, the row 164 and column 166 drivers will then provide select signals 168 on select lines 92, 94 and drive signals 170 on drive lines 96, 98, 100, 102 (FIG. 5) to the display 160.

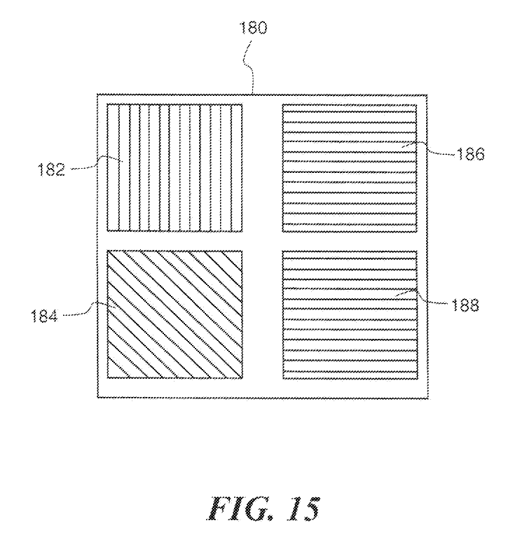

It should be noted, that the full-color display shown in FIG. 5 has one particular arrangement of light-emitting elements useful in practicing the present invention. Many other similar arrangements are known in the art such as described in U.S. patent application Ser. Nos. 10/859,314, 10/961,506, and 10,821,353, as well as U.S. application Ser. No. 11/616,330, all of which are herein included by reference. One additional alternative arrangement is the quad arrangement of light-emitting elements, such as the arrangement shown in FIG. 15. FIG. 15 illustrates a portion of a display 180 comprising a single arrangement of four light-emitting elements 182, 184, 186, 188, which may be tiled across the entire display's surface, wherein the four light-emitting elements 182, 184, 186, 188 are arranged as squares within a square. In-gamut light-emitting element 182 emits a near-white color of light, according to the present invention. Light-emitting elements 184, 188, and 186 for emit red, green, and blue light; respectively. Although one exemplary arrangement of the four elements are shown in this figure, it should be recognized that these four colored light-emitting elements may be arranged in any order within the repeating pattern. Further, alternative arrangements may be employed within neighboring repeating patterns.

The invention has been described in detail with particular reference to certain preferred embodiments thereof, but it will be understood that variations and modifications can be effected within the spirit and scope of the invention.

### Parts List

2 peak of human eye sensitivity
4 short wavelengths
6 long wavelengths
8 first gamut triangle
10 second gamut triangle
20 red spectra
22 green spectra
24 blue spectra
26 red emissive element
28 green emissive element
30 blue emissive element
32 color gamut
36 LED device
38 quantum dot inorganic light-emitting layer
40 substrate
42 anode
44 bus metal
46 cathode
50 emission spectra for red light-emitting element
52 emission spectra for green light-emitting element
54 emission spectra for blue light-emitting element
56 emission spectra for in-gamut light-emitting element
60 color gamut triangle
62 CIE coordinate of red light-emitting element
64 CIE coordinate of green light-emitting element
66 CIE coordinate of blue light-emitting element
68 CIE coordinate of in-gamut light-emitting element
70 portion of full-color display
72 within-gamut light-emitting element
74 within-gamut light-emitting element
76 red light-emitting element
78 red light-emitting element
80 green light-emitting element
82 green light-emitting element
84 blue light-emitting element
86 blue light-emitting element
88 power line
90 power line
92 select line
94 select line
96 drive line
98 drive line
100 drive line
102 drive line
104 select TFT
106 capacitor
108 power TFT
110 form first size distribution operation
112 form second size distribution operation
114 form a mixture operation
116 form mixture with conductive particles operation (optional)
118 deposit mixture operation
120 70% NTSC color gamut
122 100% NTSC color gamut
124 138% NTSC color gamut
126 chromaticity coordinate of near-white, in-gamut light-emitting element
132 RGB power consumption value for 72% NTSC color gamut
134 RGB power consumption value for 100% NTSC color gamut
136 RGB power consumption value for 138% color gamut
138 RGBW power consumption value for 72% NTSC color gamut
140 RGBW power consumption value for 100% NTSC color gamut
142 RGBW power consumption value for 138% NTSC color gamut
144 power Ratio for 70% NTSC color gamut
146 power Ratio for 100% NTSC color gamut
148 power ratio for 138% NTSC color gamut
150 minimum power consumption value
160 display
162 display processor
164 row driver
166 column driver
168 row signals
170 column signals
172 input RGB signal
174 row driver synchronization signal
176 four or more color drive signal
180 display portion
182 in-gamut light-emitting element
184 red light-emitting element
186 blue light-emitting element
188 green light-emitting element
220 spectra for D50 in-gamut light-emitting element
222 spectra for D65 in-gamut light-emitting element
224 spectra for D93 in-gamut light-emitting element
300 smaller quantum dots
302 larger quantum dots
304 conductive particles
308 colloidal light-emitting layer

What is claimed is:

1. A full-color, light-emitting display device having improved efficiency with a large color gamut, comprising:
a plurality of pixels, each pixel having four or more colors of light-emitting elements, three of the colors of light-emitting elements emitting red, green, and blue light, and at least one of the colors of light-emitting elements emitting light perceived to be within the gamut defined by the chromaticity coordinates of the red, green, and blue colored light-emitting elements, wherein the light-emitting elements for emitting red, green, and blue colors of light each comprise a different species of inorganic light-emitting particles for emitting a different color of light, and each of the red, green, and blue species produce light having an emission spectrum with a full-width, half-maximum of less than or equal to 70 nm; and
wherein the species of inorganic light-emitting particles for emitting red light emits light having a dominant wavelength of 620 nm or greater, the species of inorganic light-emitting particles for emitting blue light emits light having a dominant wavelength of 470 nm or less, and the in-gamut light-emitting element employs a plurality of species of light-emitting particles, wherein at least one of the plurality of species of light-emitting particles within the in-gamut light-emitting element has a greater luminous efficiency than both the red and the blue species of light-emitting particles within the red and blue light-emitting elements.

2. The full-color, light-emitting display device of claim 1, wherein the light-emitting particles are quantum dots.

3. The full-color, light-emitting display device of claim 1, wherein the light-emitting particles form a common, light-emitting layer.

4. The full-color, light-emitting display device of claim 3, wherein the light-emitting layer further includes non-light-emitting inorganic conductive or semiconductive particles.

5. The full-color, light-emitting display device of claim 1, wherein at least one of the plurality of species of light-emitting particles of the in-gamut light-emitting element emits either orange, cyan, green-cyan, or yellow light.

6. The full-color, light-emitting display device of claim 1, wherein at least one plurality of species of light-emitting particles of the in-gamut light-emitting element emits light at a frequency different from the frequency of light emitted by the red, green, or blue species of light-emitting particles.

7. The full-color, light-emitting display device of claim 1, wherein the combined light emitted by the plurality of species of light-emitting particles of the in-gamut light-emitting element is substantially white.

8. The full-color, light-emitting display device of claim 1, wherein the plurality of species of light-emitting particles of the in-gamut light-emitting element emits light of two complementary colors.

9. The full-color, light-emitting display device of claim 8, wherein the plurality of species of light-emitting particles of the in-gamut light-emitting element emits red and cyan light, or yellow and blue light.

10. The full-color, light-emitting display device of claim 1, wherein the plurality of species of light-emitting particles of the in-gamut light-emitting element emits light in three colors.

11. The full-color, light-emitting display device of claim 10, wherein the plurality of light-emitting particles of the in-gamut light-emitting element emits green light, orange or yellow light, and cyan light.

12. The full-color, light-emitting display device of claim 1, wherein at least one of the plurality of species of light-emitting particles of the in-gamut light-emitting element emits light of a frequency that is the same as one of the red, green, or blue species of light-emitting particles.

13. The full-color, light-emitting display device of claim 1, wherein at least one of the plurality of species of light-emitting particles of the in-gamut light-emitting element emits light of a frequency that is not the same frequency as any of the light emitted by the red, green, or blue species of light-emitting particles.

14. The full-color, light-emitting display device of claim 1, wherein the combined light emitted by the plurality of species of light-emitting particles of the in-gamut light-emitting element is substantially white and wherein the relative concentrations of the different light-emitting particles of each species forms light of a pre-determined white point.

15. The full-color, light-emitting display device of claim 1, wherein the plurality of species of light-emitting particles of the in-gamut light-emitting element emits light in a primary color and in a secondary color.

16. The full-color, light-emitting display device of claim 1, wherein the wherein the red species of inorganic light-emitting particles emits light having a dominant wavelength of 670 nm or greater.

17. The full-color, light-emitting display device of claim 1, wherein the blue species of inorganic light-emitting particles emits light having a dominant wavelength of 430 nm or less.

18. The full-color, light-emitting display device of claim 1, wherein the plurality of species of light-emitting particles of the in-gamut light-emitting element each have an emission spectrum with a full-width, half-maximum of less than or equal to 70 nm.

19. The full-color, light-emitting display device of claim 1, wherein each of the red, green, and blue species produce light having an emission spectrum with a full-width, half-maximum of less than or equal to 50 nm.

20. The full-color, light-emitting display device of claim 1, wherein the in-gamut light emitting element reduces power consumption by at least one-half with respect to a full-color light emitting display device without an in-gamut light emitting element.
